(19) United States
(12) Patent Application Publication
(10) Pub. No.: US 2010/0123715 A1
(43) Pub. Date: May 20, 2010

(54) METHOD AND SYSTEM FOR NAVIGATING VOLUMETRIC IMAGES

(75) Inventors: Joger Hansegard, Oslo (NO); Stein Rabben, Sofiemyr (NO); Rune Torkildsen, Bergen (NO)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/271,515

(22) Filed: Nov. 14, 2008

(51) Int. Cl. G06T 15/30; G06K 9/00; G06T 15/00

(52) U.S. Cl. 345/419; 382/128; 345/620

(57) ABSTRACT

Navigating volumetric images with reference to an anatomic structure is disclosed. The systems and methods include navigating a volumetric image with reference to an axis corresponding to an anatomical structure. The anatomical structure may be a cardiovascular structure, such as cardiac chambers, walls, valves, and/or blood vessels. The navigation may include rotating, slicing, and/or cropping volumetric data with reference to the anatomical structure.

### FIELD OF THE INVENTION

This invention relates generally to diagnostic imaging systems, and more particularly, to methods and systems for navigating volumetric images with reference to an anatomical structure.

### BACKGROUND OF THE INVENTION

Medical imaging systems are used in different applications to image different regions or areas (e.g., different organs) of patients. For example, ultrasound systems are finding use in an increasing number of applications, such as to generate images of the heart. These images are then displayed for review and analysis by a user. The images also may be modified or adjusted to better view or visualize different regions or objects of interest, such as different views of the heart. Typically while performing cardiac ultrasound imaging, an ultrasound probe axis is oriented such that it is parallel to a main axis of the cardiac chamber. While analyzing or navigating the image data on a screen, the viewing direction may be manipulated using a user interface.

Navigation within a volumetric image is often challenging for a user and results in a time consuming and tedious process when, for example, attempting to display different views of an organ of interest. A user is typically able to adjust slicing planes that cut into the imaged object within the volumetric image data, such that multiple views through the imaged object may be displayed. Generally, this is done with reference to acquisition geometry, such as an axis corresponding to the transducer or the probe.

In volume imaging, another important functionality is the ability to crop parts of the imaged object in order to look inside the object. The crop function can be performed in different ways. Cropping is commonly performed by defining a plane that cuts into the imaged object and the part of the object on one side of that plane is removed from the rendering. This is again performed conventionally with reference to the axis of acquisition geometry.

Generally in a cardiac navigation model, the image data is navigated with reference to the acquisition geometry, and this is useful when the main axis of the cardiac chamber is in alignment with the acquisition geometry. However, in ultrasound imaging, it can be difficult to achieve sufficiently good alignment of the acquisition geometry to the main cardiac chamber axis. In situations where the navigation axis is not in alignment with the cardiac chamber axis and the navigation is done with reference to the navigation axis, then the image data does not rotate or get navigated about the heart chamber's axis. This can result in displaying a titled cardiac chamber Clinical investigation of the heart conventionally utilizes a so-called apical view, where the top of the cardiac chamber is displayed as the top-most part of the chamber when depicted on the screen. It is therefore desirable to allow a simple way of continuously rotating/manipulating about the true anatomical main axis of the chamber.

Some solutions suggest manipulating the image data with reference to the acquisition geometry and adjusting the entire data set to align the displayed image data to the cardiac chamber axis. However, by doing this, the navigation model becomes confusing. And since the acquisition geometry has been titled, the manipulation of the image data no longer corresponds to the intuitive movement of image data displayed on the screen.

Thus, it will be beneficial to provide a navigation system and method for navigating volumetric images independent of acquisition geometry.

### SUMMARY OF THE INVENTION

The above-mentioned shortcomings, disadvantages, and problems are addressed herein, which will be understood by reading and understanding the following specification.

One embodiment of the present invention provides a method of navigating volumetric image data. The method comprises: navigating a volumetric image data with reference to an anatomical structure. The anatomical structure includes a cardiovascular structure.

In another embodiment, a method of navigating ultrasound volumetric images is disclosed. The method comprises: displaying an ultrasound volumetric image; identifying a cardiovascular axis with reference to a cardiovascular structure; aligning a navigation axis with the cardiovascular axis- and navigating the volumetric image with reference to the aligned navigation axis.

In yet another embodiment, a system for navigating a volumetric image data is disclosed. The imaging system comprises: a probe, processor, memory, and a display. Further, the processor is configured to navigate a volumetric image data with reference to an anatomical structure.

In yet another embodiment, a processor for navigating cardiac volumetric image is disclosed. The processor comprises: an identification module configured to identify a cardiac vascular axis from a cardiovascular structure; an alignment module configured to align a navigation axis with the cardiovascular axis; and a navigation module configured to navigate a volumetric image with reference to the aligned navigation axis.

In yet another embodiment, a machine readable medium or media having recorded thereon instructions is configured to instruct a system comprising a processor, memory, and a display, to navigate volumetric image data. The medium comprises: a routine for navigating a volumetric image data with reference to an anatomical structure.

### BRIEF DESCRIPTION OF THE DRAWINGS

FIG. 1 is a flowchart illustrating a navigation method as described in an embodiment of the invention;

FIG. 2 is a block diagram of a system capable of navigating volumetric images as described in an embodiment of the invention;

FIG. 3 is a diagrammatic representation of a processor configured to navigate cardiac volumetric images as described in an embodiment of the invention; and

FIGS. 4A and 4B illustrate diagrammatic representations of rotating a cardiac image conventionally and as described in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical, and/or other changes may be made without departing from the scope of the embodiments. The following detailed description is, therefore, not to be taken as limiting the scope of the invention.

Various embodiments of the present invention are directed to volumetric image data navigation. The navigation is done with reference to an anatomical structure.

In an embodiment, navigation of an ultrasound volumetric image is disclosed. For example, an ultrasound cardiac 2D slice and 3D visualization data are navigated using an axis defined with reference to a cardiovascular structure.

In an embodiment, the invention facilitates aligning a navigation axis with reference to an anatomical structure and navigating the volumetric image using the aligned navigation axis.

In an exemplary embodiment, navigating a volumetric cardiac 3D visualization data or 2D image slice is disclosed. The navigation axis is aligned with reference to a cardiovascular structure including cardiac chambers, walls, valves, and blood vessels.

In an exemplary embodiment, adjusting longitude and latitude of a cardiac image in a spherical navigation coordinate system with reference to a navigation axis aligned with a cardiovascular axis is disclosed.

In an embodiment, an ultrasound imaging system is disclosed, wherein the acquired volumetric images are navigated with reference to an anatomical structure.

Though an example illustrated in the specification refers to cardiovascular images, the application of the invention need not be limited to this and may be applied to any organ, including, but not limited to kidneys, liver, spleen, and brain. Furthermore, even though the invention is explained mainly with reference to ultrasound volumetric images/image data, the volumetric images from other modalities, such as Magnetic Resonance Imaging (MRI), Computed Tomography (CT), Positron Emission Technology (PET), and/or X-Ray, etc., can be also used.

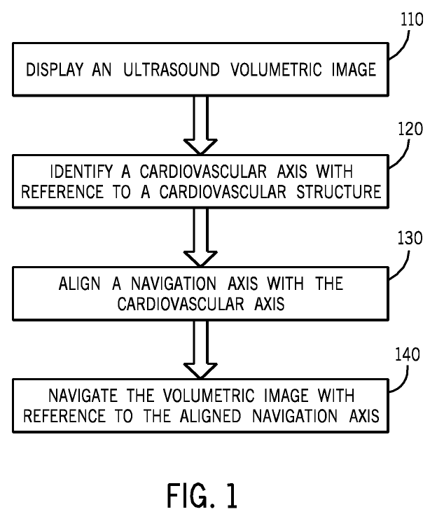

FIG. 1 is a flowchart illustrating a navigation method as described in an embodiment of the invention. At step 10, a volumetric image is displayed. The volumetric image may include 2D image slices or 3D visualization of volumetric image data including volume renderings and surface renderings. The volumetric image may be acquired and displayed on a display, or it may be obtained from an image-storing device. The volumetric image may be an ultrasound image, or an image obtained by MRI, CT, PET, X-ray etc. At step 120, a cardiovascular axis is identified with reference to a cardiovascular structure. The cardiovascular structure may include cardiac chambers, walls, valves, and/or blood vessels. The cardiovascular axis may be obtained manually or automatically.

In an embodiment, the cardiovascular axis is obtained by identifying the location of a plurality of markers appearing in a long axis, short axis, and apical view. Alternately, the cardiovascular axis may be identified using automated techniques.

At step 130, a navigation axis is aligned with reference to the cardiovascular axis. In an embodiment, the navigation axis may be a probe axis in an ultrasound imaging system. At step 140, the volumetric image is navigated with reference to the aligned navigation axis. The navigation might include rotating, slicing and/or cropping of the image.

In an embodiment, cropping the cardiac image, or part of the same, may be done in order to look inside the object with reference to the cardiovascular axis. The crop function can be performed in different ways. For example, cropping is commonly performed by defining one or multiple planes that cut into the imaged object, and the part of the object on one side of that plane is removed from the rendering. The plane is defined with reference to the cardiovascular axis.

In another embodiment, an operator generates one view of a heart by slicing the image to generate a single view, and then rotating and/or translating the image to another view, and then slicing the volumetric data at another location to generate another view. This process may be repeated until multiple images defining different views are generated. For example, slicing planes may be rotated and translated within an ultrasound volume to generate standard views (e.g., standard apical views) for analysis. This is done often with reference to the cardiovascular axis.

In an example, a surface model, volume rendering, or sliced view of a cardiac image is navigated using a track ball. The latitude and longitude of the image is navigated with reference to the cardiovascular axis. The longitude and latitude is related to an anatomically aligned coordinate system related to the cardiovascular axis. By manipulating the image with reference to the cardiovascular axis, the image may be navigated. The navigation process may include at least one of slicing, cropping and/or rotating the volumetric image with reference to the cardiovascular axis. The manipulation may be done using the track ball. When manipulating the track ball from left to right, the navigation model would rotate the slice plane or volume or surface rendering about the cardiovascular axis. Similarly, when manipulating the track ball from top to bottom, the navigation model would rotate the slice plane or volume or surface renderings about an axis orthogonal to the cardiovascular axis.

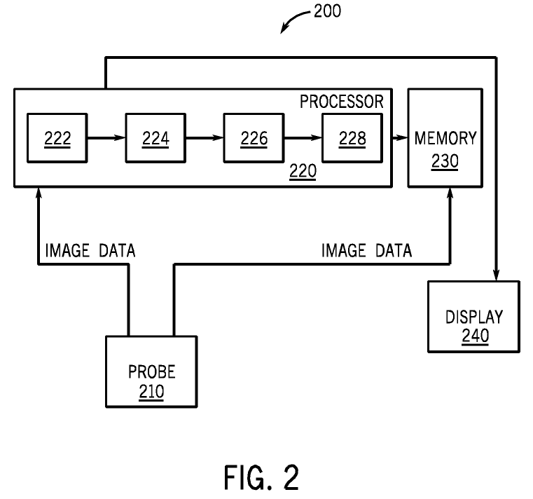

FIG. 2 is a block diagram of a system capable of navigating volumetric images with reference to an anatomical structure as described in an embodiment of the invention. The system 200 is configured to have a probe 210 or transducer configured to acquire raw medical image data. The coordinate system of the image data is defined with reference to the probe axis. The volumetric data may be 2D slices or 3D renderings. In some embodiments, the probe 210 is an ultrasound transducer and the system 200 is an ultrasound imaging system. The system 200 may acquire a volumetric image of an organ and store it in an image-storing device (not shown). A data memory 230 stores acquired raw image data, which may be processed by a processor 220 in some embodiments of the present invention. A display 240 (e.g., an internal display) is also provided and configured to display a medical image in various forms, such as 2D slices or 3D renderings.

To display a medical image obtained using the probe 210, the processor 220 is provided with a software or firmware memory 222 containing instructions to perform image-processing techniques on the acquired raw medical image data. Although shown separately in FIG. 2, it is not required that the memory 222 and 230 be physically separate memories. Dedicated hardware may be used instead of software and/or firmware for performing image processing, or a combination of dedicated hardware and software, or software in combination with a general purpose processor or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 220.

The software or firmware memory 222 can comprise a read only memory (ROM), random access memory (RAM), a miniature hard drive, a flash memory card, or any kind of device (or devices) configured to read instructions from a machine-readable medium or media. The instructions contained in the memory 222 further include instructions to produce a medical image of suitable resolution for display and navigation on the display 240, and/or to send acquired raw or scan converted image data stored in the data memory 230 to an external device (not shown), such as a computer, and other instructions to be described below. The image data may be sent from the processor 220 to the external device via a wired or wireless network (or direct connection, for example, via a serial or parallel cable or USB port) under control of the processor 220 and a user interface (not shown). In some embodiments, the external device may be a computer or a workstation having a display and memory. The user interface (which may also include the display 240) may also receive data from a user and supply the data to the processor 220. In some embodiments, the display 240 may include an x-y input, such as a touch-sensitive surface and a stylus (not shown), to facilitate user input of data points and locations.

In an embodiment, the system 200 may be configured as a miniaturized device. As used herein, “miniaturized” means that the system 200 is a handheld or hand-carried device or is configured to be carried in a person's hand, briefcase-sized case, or backpack. For example, the system 200 may be a hand-carried device having a size of a typical laptop computer.

Embodiments of the present invention can comprise software or firmware instructing a computer to perform certain actions. Some embodiments of the present invention comprise stand-alone workstation computers that include memory, a display, and a processor. The workstation may also include a user input interface (which may include, for example, a mouse, a touch screen and stylus, a keyboard with cursor keys, or combinations thereof). A user may interact with the image displayed or interact in the navigation process using the user interface. The memory may include, for example, random access memory (RAM), flash memory, or read-only memory. For purposes of simplicity, devices that can read and/or write media on which computer programs are recorded are also included within the scope of the term “memory.” A non-exhaustive list of media that can be read with such a suitable device includes CDs, CD-RWs, DVDs of all types, magnetic media (including floppy disks, tape, and hard drives), flash memory in the form of sticks, cards, and other forms, ROMs, etc., and combinations thereof.

Some embodiments of the present invention may be incorporated into a medical imaging apparatus, such as the system 200 of FIG. 2, which can include an ultrasound imaging system or other. In correspondence with a stand-alone workstation, the “computer” can be considered as the apparatus itself or at least a portion of the components therein. For example, the processor 220 may comprise a general purpose processor with memory, or a separate processor and/or memory may be provided. The display 240 corresponds to the display of the workstation, while the user interface corresponds to the user interface of the workstation. Whether a stand-alone workstation or an imaging apparatus is used, software and/or firmware (hereinafter referred to generically as “software”) can be used to instruct the computer to perform the inventive combination of actions described herein. Portions of the software may have specific functions, and these portions are herein referred to as “modules” or “software modules.” However, in some embodiments, these modules may comprise one or more electronic hardware components or special-purpose hardware components that may be configured to perform the same purpose as the software module or to aid in the performance of the software module. Thus, a “module” may also refer to hardware or a combination of hardware and software performing a function.

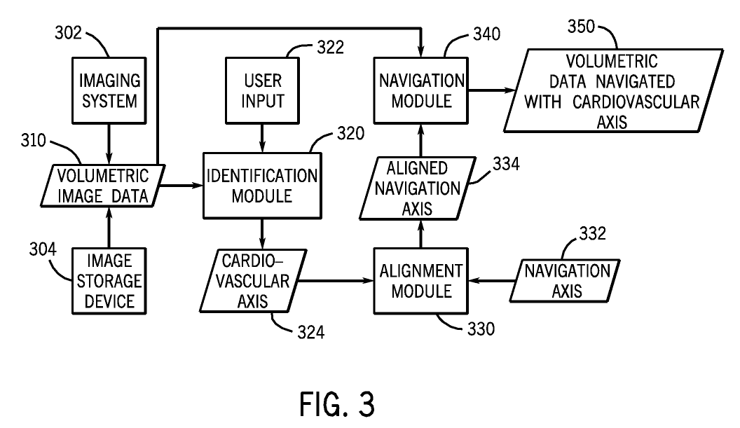

In some embodiments of the present invention, the processor 220 is configured to navigate the volumetric data with reference to an anatomical axis of a cardiovascular structure. The processor 220 may include various modules that may be implemented within the processor 220 or computer by a stored program and/or within special purpose hardware. These modules include an identification module 224 for identifying an anatomical axis with reference to an anatomical structure. The processor 220 further includes an alignment module 226 for aligning a navigation axis with the anatomical structure. A navigation module 228 is further provided to navigate the volumetric image with the reference to the navigation axis. The display 240 is configured to display the volumetric image and navigation process. The identification module 224, the alignment module 226, and the navigation module 228 are configured to operate iteratively to facilitate navigation of the volumetric image with reference to an anatomical structure. Different modules referred shall be explained in detail with reference to FIG. 3.

FIG. 3 is a diagrammatic representation of a processor configured to navigate cardiac volumetric images as described in an embodiment of the invention. Volumetric image data 310 is obtained from an imaging system 302 or from an image storage device 304. The volumetric mage data may be an ultrasound volumetric image. User input 322 and volumetric image data 310 are provided to an identification module 320, which is configured to obtain a cardiovascular axis 324 with reference to a cardiovascular structure. The cardiovascular structure includes cardiac chambers, walls, vessels etc. The user input 322 is not necessarily required for all embodiments of the present invention, and some embodiments need not provide any functionality for gathering user input 322, optionally or otherwise. The user input 322, when provided, includes initialization data, and it could also include other instructions stored in a software memory such as 222 (shown in FIG. 2). The identification module 320 can be any known method that can be used to identify the cardiovascular axis.

In an embodiment, the cardiovascular axis 324 is obtained by identifying the location of a plurality of markers appearing in a long axis, short axis, and apical view.

In an embodiment, the cardiovascular axis 324 may be obtained by an automated method. The cardiovascular structure may also be identified through an automated system. This method might include automatically analyzing the cardiac image using a deformable model, for instance a parametric model with parameters for local shape deformations and/or global transformations. If a parametric model is used, a predicted state vector is created for the parametric model using a kinematic model. The parametric model is deformed using the predicted state vector, and a plurality of actual points for the 3D structure is determined using a current frame of the 3D image, and displacement values and measurement vectors are determined using differences between the plurality of actual points and the plurality of predicted points. The displacement values and the measurement vectors are filtered to generate an updated state vector and an updated covariance matrix, and an updated parametric model is generated for the current image frame using the updated state vector. From the identified cardiovascular structure, the cardiovascular axis 324 corresponding to the same may be identified.

The cardiovascular axis 324, or the corresponding coordinates, is provided to an alignment module 330. The alignment module 330 is also configured to receive a navigation axis 332 or its coordinates. In an embodiment, the navigation axis 332 may be the geometrical axis or coordinates based on which the images being acquired. In an example, the navigation axis 332 is a probe axis. The alignment module 330 is further configured to align the navigation axis 332 with the cardiovascular axis 324, and thus, an aligned navigation axis 334 is obtained. Alternately, the cardiovascular axis 324 is set as the navigation axis 332. This could be achieved by mapping the navigation axis coordinates with the cardiovascular axis coordinates.

The volumetric image data 310, along with the aligned navigation axis 334, is provided to a navigation module 340. The navigation module 340 is configured to navigate within the volumetric image with reference to the aligned navigation axis 334.

The volumetric image data 310 may be obtained from the image system or from the image-storing device. The volumetric image data 310, as used herein, may comprise any one or more of image data, synthetic image data, a secondary (or tertiary, etc.) modality of image data (for example, a CT or MRI image), and a cardiac model or any other volumetric anatomical model. The volumetric image data 310 is navigated with reference to the aligned navigation axis 334, shown as 350, and hence, the navigation facilitates a navigation method independent of acquisition geometry. Since the navigation axis 332 is fully aligned with the cardiovascular axis 324, extraction of clinically relevant views is thereby simplified.

It should be noted that configurations of the present invention are not limited to cardiac applications or medical applications, in which case the volumetric image data 310 to be displayed would be data representative of a different object to be manipulated with reference to a recognizable structure, such as an anatomical structure in the event of medical imaging.

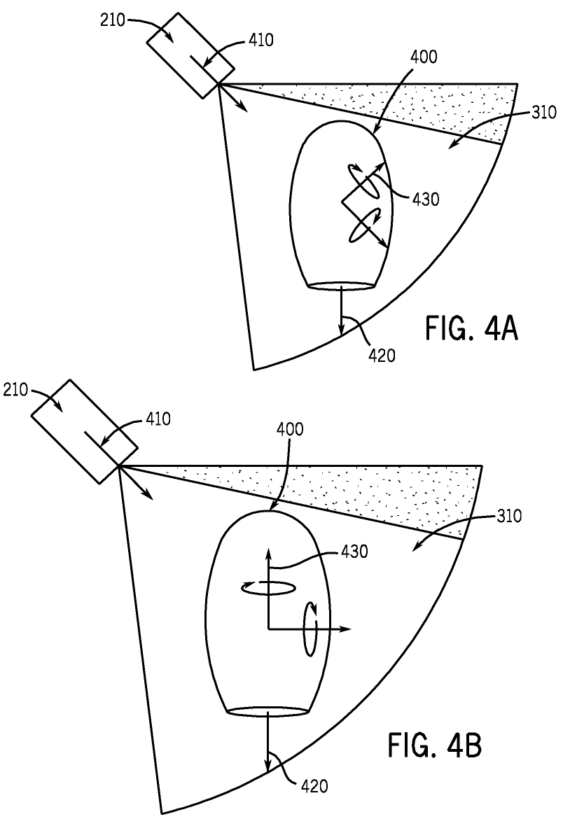

FIGS. 4A and 4B respectively illustrate diagrammatic representations of rotating a cardiac image conventionally and as described in an embodiment of the invention. FIG. 4A represents rotating the cardiac chamber 400 with reference to a probe axis 410. Here, the navigation axis 430 is aligned with the probe axis 410, and the probe axis 410 is not well aligned with the cardiac chamber axis 420. The rotation is done with reference to the navigation axis 430, and the data displayed for the cardiac chamber 400 will look titled on the screen. A left/right trackball movement (not shown) will cause the data to rotate about the probe axis 410 when using the standard navigation model. However, since the cardiac chamber axis 420 is not well aligned with the probe axis 410, the displayed data does not rotate about the cardiac chamber axis 420. Clinical investigation of the heart conventionally utilizes so-called apical view, where the top of the heart chamber is always the top-most part of the chamber when depicted on a screen. Hence, the displayed data of the cardiac chamber 400 is aligned on the screen by rotating the acquisition geometry or the probe axis 410, as shown in FIG. 4A. The entire data set has been adjusted to align the cardiac chamber axis 420 to the screen. The problem associated with the method is that the classical navigation model becomes confusing. Since the acquisition geometry has been tilted, the left/right movement of the trackball no longer corresponds to the intuitive horizontal rotation on the screen. In more extreme situations, for example, where the entire acquisition geometry has been rotated 90 degrees, the left/right movement of the trackball may even cause a vertical rotation on the screen. As for the unaligned case, it remains impossible to continuously rotate the data set about the cardiac chamber axis 420.

In FIG. 4B, the navigation axis 430 is aligned with reference to the cardiac chamber axis 420. This allows intuitive rotation of the cardiac chamber 400, even if the image data is not properly aligned to the same. In this navigation model, the navigation axis 420 has been aligned to the cardiac chamber axis 420, as illustrated above. The volumetric image data 310 is rotated with reference to the aligned navigation axis 430, and hence the rotation facilitates a navigation method independent of acquisition geometry. Since the navigation axis 430 is fully aligned with the cardiac chamber axis 420, extraction of clinically relevant views is simplified.

The above-description of the embodiments of the methods and systems has the technical effect of navigating volumetric images independent of acquisition geometry. The method and system facilitates navigating volumetric images with reference to an anatomic structure.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and/or separately from other components described herein. Further, the steps involved in the workflow need not follow the sequence illustrated in the figures, and not all of the steps in the workflow need to be necessarily performed in order to complete the method.

While the invention has been described with reference to preferred embodiments, those skilled in the art will appreciate that certain substitutions, alterations, and/or omissions may be made to the embodiments without departing from the spirit of the invention. Accordingly, the foregoing description is meant to be exemplary only, and should not limit the scope of the invention as set forth in the following claims.

We claim:

1. A method of navigating volumetric image data, comprising:
navigating volumetric image data with reference to an anatomical structure.

2. The method as claimed in claim 1, wherein the anatomical structure is a cardiovascular structure.

3. The method as claimed in claim 2, wherein the cardiovascular structure includes:
cardiac chambers, walls, valves, and/or blood vessels.

4. The method as claimed in claim 1, wherein the navigation includes: rotating, slicing, and/or cropping the volumetric data with reference to the anatomical structure.

5. The method as claimed in claim 1, wherein the method further includes:
automatically aligning a navigation coordinate system with the anatomical structure.

6. The method as claimed in claim 1, wherein the volumetric image data is selected from two dimensional image slices and/or three dimensional visualization of volumetric image data.

7. The method as claimed in claim 6, wherein the three dimensional visualization volumetric image data includes: volume renderings and/or surface renderings.

8. The method as claimed in claim 1, wherein the navigation includes: adjusting at least one of longitude and latitude, in a spherical coordinate system, of two dimensional image slices and/or three dimensional renderings with reference to the anatomical structure.

9. A method of navigating ultrasound volumetric images, comprising:
displaying an ultrasound volumetric image;
identifying a cardiovascular axis with reference to a cardiovascular structure;
aligning a navigation axis with the cardiovascular axis; and
navigating the volumetric image with reference to the aligned navigation axis.

10. The method as claimed in claim 9, wherein identifying the cardiovascular axis includes: identifying an axis with reference to the cardiovascular structure including cardiac chambers, walls, valves, and/or blood vessels.

11. The method as claimed in claim 10, wherein identifying the cardiovascular axis includes: identifying a location of a plurality of markers appearing in long axis, short axis, and/or apical cardiac views.

12. The method as claimed in claim 10, wherein identifying the cardiovascular axis includes: identifying the cardiovascular axis with reference to the cardiovascular structure identified through an automated system.

13. The method as claimed in claim 9, wherein navigating comprises: adjusting at least one of longitude and latitude, in a spherical coordinate system, of two dimensional image slices and/or three dimensional renderings with reference to the cardiovascular structure.

14. A system for navigating volumetric image data, comprising: a probe, a processor, memory, and a display;
wherein the processor is configured to navigate volumetric image data with reference to an anatomical structure.

15. The system as claimed in claim 14, wherein the anatomical structure includes a cardiovascular structure.

16. The system as claimed in claim 14, wherein the volumetric image data includes at least one of two dimensional slices and/or three dimensional renderings.

17. The system as claimed in claim 14, wherein the system is an ultrasound system.

18. The system as claimed in claim 14, wherein the processor is configured to alter at least one of longitude and latitude, in a spherical coordinate system, of the volumetric image data with reference to the anatomical structure, in accordance with a user input.

19. The system as claimed in claim 14, wherein the processor is configured to perform at least one of: cropping, rotating, and/or slicing with reference to the anatomical structure.

20. A processor for navigating a cardiac volumetric image, comprising:
an identification module configured to identify a cardiac vascular axis from a cardiovascular structure;
an alignment module configured to align a navigation axis with the cardiovascular axis; and
a navigation module configured to navigate a cardiac volumetric image with reference to the aligned navigation axis.

21. The system as claimed in claim 20, wherein the identification module is further configured to identify the cardiac vascular axis with reference to a location of a plurality of markers appearing in long axis, short axis, and/or apical cardiac views.

22. The system as claimed in claim 20, wherein the identification module is further configured to automatically identify the cardiovascular axis.

23. A machine readable medium or media having recorded thereon instructions configured to instruct a system comprising a processor, memory, and a display, to navigate volumetric image data comprising a routine for navigating volumetric image data with reference to an anatomical structure.
